(19) United States
(12) Patent Application Publication
(10) Pub. No.: US 2009/0082153 A1
(43) Pub. Date: Mar. 26, 2009

(54) Driving device

(75) Inventors: Masato Fujikawa, Toyota-shi (JP); Masatoshi Adachi, Nishikamo-gun (JP); Jun Ichiyanagi, Nishio-shi (JP)

Correspondence Address: OLIFF & BERRIDGE, PLC, P.O. BOX 320850, ALEXANDRIA, VA, 22320-4850, US

(73) Assignees: TOYOTA JIDOSHA KABUSHIKI KAISHA, TOYOTA-SHI (JP); AISIN AW CO., LTD., ANJO-SHI (JP)

(21) Appl. No.: 11/794,813

(22) PCT Filed: Oct. 16, 2006
(86) PCT No.: PCT/JP2006/320977

§ 371 Date: Jul. 6, 2007

(30) Foreign Application Priority Data
Oct. 19, 2005 (JP) 2005-304337

(51) Int. Cl. F16D 48/02; F16D 25/12

(52) U.S. Cl. 475/128; 475/137

(57) ABSTRACT

In a driving device that includes a mechanical oil pump operated by power of an engine and a motor oil pump EOP operated by power of a motor, provided in parallel with each other, and check valves on discharge sides of the pumps, and pumps oil from any of the pumps and supplies the oil to a clutch included in a transmission, a through hole 68a for releasing air that communicates with a discharge port 68 is formed in a case 61 of the mechanical oil pump MOP. This allows air trapped in when driving of the mechanical oil pump MOP is started along with a start of the engine to be quickly discharged to quickly increase internal pressure to pressure required for opening the check valve, and thus oil can be supplied to the clutch of the transmission via the check valve to quickly operate the clutch.

### TECHNICAL FIELD

The present invention relates to a driving device used for driving a clutch included in a transmission mounted on a device.

### BACKGROUND ART

A conventionally proposed driving device of this type has been mounted in a vehicle as a hydraulic circuit for driving a clutch included in an automatic transmission, and included a first check valve placed on an output side of a mechanical pump that stops operation in stopping idling an engine, and a second check valve placed on an output side of a motor pump that is provided in parallel with the mechanical pump and is operated in stopping idling (for example, see Japanese Patent Laid-Open No. 2005-90659). In this device, the first check valve inhibits oil discharged from the motor pump that is operated in stopping idling from flowing into the mechanical pump, and the second check valve inhibits oil discharged from the mechanical pump from flowing into the motor pump, thereby reducing sizes of the mechanical pump and the motor pump.

### DISCLOSURE OF THE INVENTION

In the above described driving device, for example, the oil sometimes cannot be quickly supplied to the clutch when the operation of the mechanical pump is started, thereby preventing quick engagement of the clutch. When the operation of the mechanical pump is stopped along with a stop of the engine, air is sometimes trapped in an oil passage around the mechanical pump with the passage of time. If the operation of the mechanical pump is started with the air being trapped in, it takes time to release the air and reach pressure required for opening the first check valve, and a delay occurs before sufficient hydraulic pressure acts on the clutch.

A driving device of the present invention has an object to solve such problems and more quickly operate a clutch included in a transmission.

At least part of the above and the other related objects is attained by a driving device of the invention having the configurations discussed below.

The present invention is directed to a driving device used for driving a clutch included in a transmission mounted on a vehicle. The driving device includes: a first pump that pumps a working fluid to be supplied to the clutch; a first check valve provided on an output side of the first pump; and an air discharge portion that is formed in a channel between the first pump and the first check valve and can discharge air trapped in the channel along with driving of the first pump.

In the driving device of the present invention, the air discharge portion that can discharge air trapped in the channel along with driving of the first pump is formed in the channel between the first pump and the first check valve, and thus when operation of the first pump is started, the air trapped between the first pump and the first check valve can be discharged from the air discharge portion. This allows pressure to be quickly increased to pressure required for opening the first check valve from the first pump, and allows a working fluid to be quickly supplied to the clutch.

In one preferable embodiment of the driving device of the invention, the driving device further includes: a second pump that is provided in parallel with the first pump, and pumps the working fluid to be supplied to the clutch; and a second check valve provided on an output side of the second pump. In this case, the second pump is a motor pump driven by receiving supply of electric power.

In another preferable embodiment of the driving device of the present invention, the transmission is connected to a rotating shaft of a motor mounted on the vehicle and a drive shaft coupled to an axle, and an engagement state of the clutch is changed to switch a gear change stage to transmit power of the shafts.

### BRIEF DESCRIPTION OF THE DRAWINGS

FIG. 1 schematically shows a configuration of a vehicle 10 including a driving device 40 that drives a brake of a transmission 30 as an embodiment of the present invention;

FIG. 2 schematically shows a configuration of the transmission 30;

FIG. 3 schematically shows a configuration of a driving device 40 according to an embodiment; and

FIG. 4 shows a configuration of an example of a sectional configuration of a mechanical oil pump MOP.

### BEST MODE FOR CARRYING OUT THE INVENTION

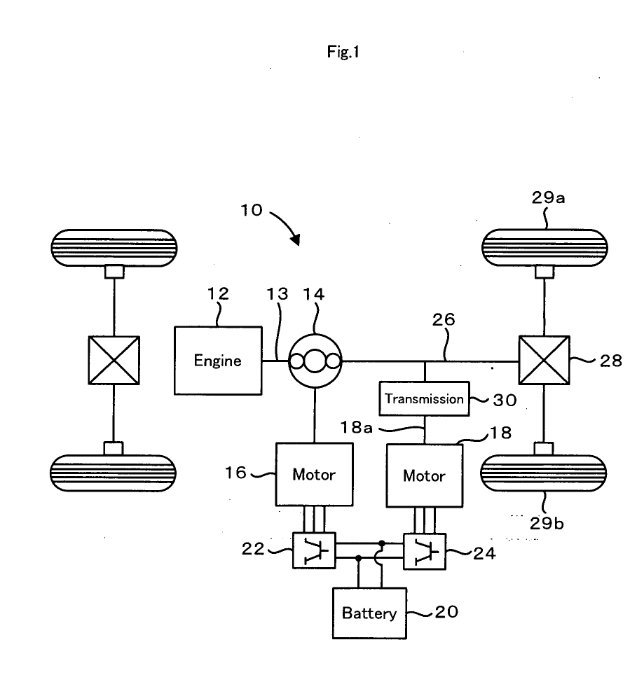

Now, the best mode for carrying out the invention will be described with reference to an embodiment. FIG. 1 schematically shows a configuration of a vehicle 10 including a driving device 40 that drives a brake of a transmission 30 as an embodiment of the present invention. The vehicle 10 of the embodiment includes an engine 12 as an internal combustion engine that outputs power with fuel, a planetary gear 14 having a carrier connected to a crankshaft 13 of the engine 12, a motor 16 connected to a sun gear of the planetary gear 14, a motor 18 connected to a drive shaft 26 coupled to a ring gear of the planetary gear 14 via the transmission 30, and a battery 20 that supplies and receives electric power to and from the two motors 16 and 18 via inverters 22 and 24. The drive shaft 26 is connected to wheels 29a and 29b via a differential gear 28, and power output to the drive shaft 26 is used as power for running.

In the vehicle 10 of the embodiment, the engine 12 and the two motors 16 and 18 are operated and controlled so that torque demand required based on accelerator operation of a driver is output to the drive shaft 26. Operation control of the engine 12 and the two motors 16 and 18 includes an engine operation mode in which the engine 12 and the motors 16 and 18 are operated and controlled so that the engine 12 is operated and power output from the engine 12 with or without charge and discharge of the battery 20 is subjected to torque conversion by the two motors 16 and 18 and the planetary gear 14 to output torque demand to the drive shaft 26, and a motor operation mode in which the operation of the engine 12 is stopped and control is performed so that torque demand is output to the drive shaft 26 only with power from the motor 18.

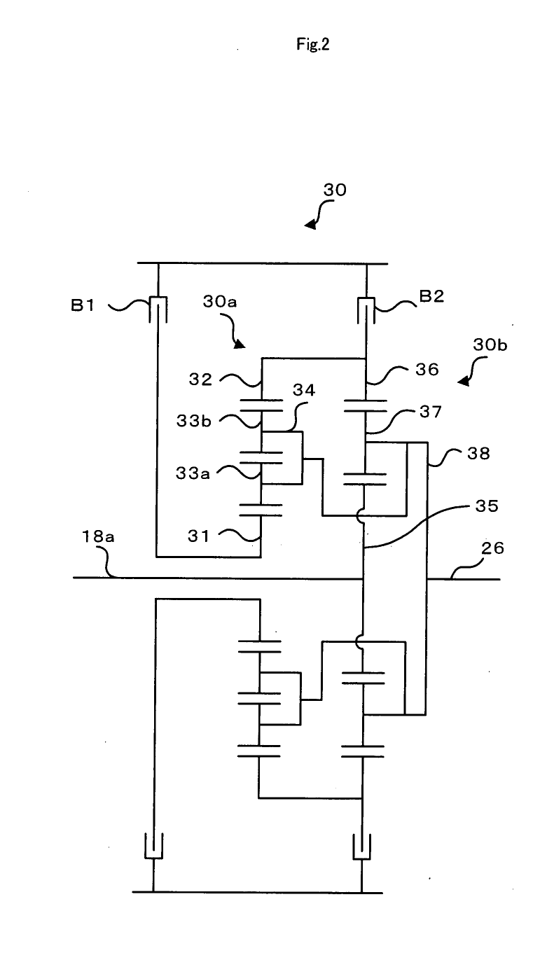

The transmission 30 is configured to perform connection and disconnection of a rotating shaft 18a of the motor 18 and the drive shaft 26, and be able to transmit connection of the shafts to the drive shaft 26 with rotation speed of the rotating shaft 18a of the motor 18 being reduced to a second stage. An example of a configuration of the transmission 30 is shown in FIG. 2. The transmission 30 shown in FIG. 2 is constituted by a double pinion planetary gear mechanism 30a, a single pinion planetary gear mechanism 30b, and two brakes B1 and B2. The double pinion planetary gear mechanism 30a includes a sun gear 31 as an external gear, a ring gear 32 as an internal gear placed concentrically with the sun gear 31, a plurality of first pinion gears 33a that mesh with the sun gear 31, a plurality of second pinion gears 33b that mesh with the first pinion gear 33a and the ring gear 32, and a carrier 34 that couples and rotatably and revolvably holds the plurality of first pinion gears 33a and the plurality of second pinion gears 33b, and the sun gear 31 can be freely rotated or stopped by turning on/off the brake B1. The single pinion planetary gear mechanism 30b includes a sun gear 35 as an external gear, a ring gear 36 as an internal gear placed concentrically with the sun gear 35, a plurality of pinion gears 37 that mesh with the sun gear 35 and the ring gear 36, and a carrier 38 that rotatably and revolvably holds the plurality of pinion gears 37, the sun gear 35 is coupled to the rotating shaft 18a of the motor 18, the carrier 38 is coupled to the drive shaft 26, and the ring gear 36 can be freely rotated or stopped by turning on/off the brake B2. The double pinion planetary gear mechanism 30a and the single pinion planetary gear mechanism 30b are coupled by the ring gear 32, the ring gear 36, the carrier 34, and the carrier 38. The transmission 30 turns off the brake B1 and turns on the brake B2 to reduce speed of rotation of the rotating shaft 18a of the motor 18 at a relatively high reduction gear ratio and transmit the rotation to the drive shaft 26 (this state is referred to as a state of Lo gear), and turns on the brake B1 and turns off the brake B2 to reduce speed of the rotation of the rotating shaft 18a of the motor 18 at a relatively low reduction gear ratio and transmit the rotation to the drive shaft 26 (this state is referred to as a state of Hi gear).

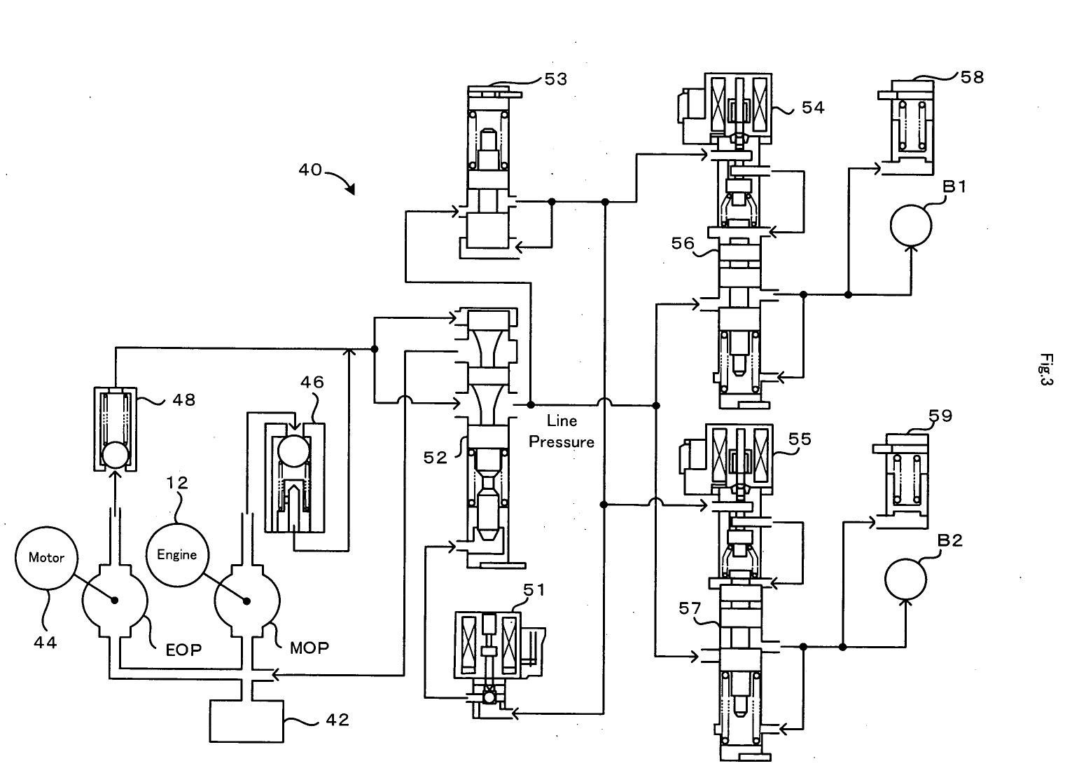

The brakes B1 and B2 of the transmission 30 are turned on/off by hydraulic pressure from a hydraulic circuit as a driving device 40 of the embodiment. FIG. 3 shows an example of a configuration of the driving device 40 of the embodiment. As shown, the driving device 40 of the embodiment is constituted by a mechanical oil pump MOP that sucks and pumps oil stored in an oil tank 42 with power from the engine 22, a motor oil pump EOP that is provided in parallel with the mechanical oil pump MOP and sucks and pumps oil stored in the oil tank 42 with power from a motor 44, check valves 46 and 48 provided on a discharge side of the mechanical oil pump MOP and a discharge side of the motor oil pump EOP, a three-way solenoid 51 and a pressure control valve 52 that can switch between two levels of pressure of oil pumped from the mechanical oil pump MOP and the motor oil pump EOP (line pressure), linear solenoids 54 and 55, control valves 56 and 57, and accumulators 58 and 59 that independently act on the brakes B1 and B2 with pressure that can adjust the line pressure, and a modulator valve 53 that reduces the line pressure and supplies the pressure to each input port of the three-way solenoid 51 and the linear solenoids 54 and 55. The motor oil pump EOP is controlled by an unshown electronic control unit so as to stop operation thereof when the mechanical oil pump MOP is operated along with the operation of the engine 12, and be operated when the operation of the mechanical oil pump MOP is stopped along with operation stop of the engine 12. The check valves 46 and 48 are provided on the discharge side of the mechanical oil pump MOP and on the discharge side of the motor oil pump EOP, and thus the check valve 46 can inhibit oil pumped by the operation of the motor oil pump EOP from flowing into the mechanical oil pump MOP, and the check valve 48 can inhibit oil pumped by the operation of the mechanical oil pump MOP from flowing into the motor oil pump EOP.

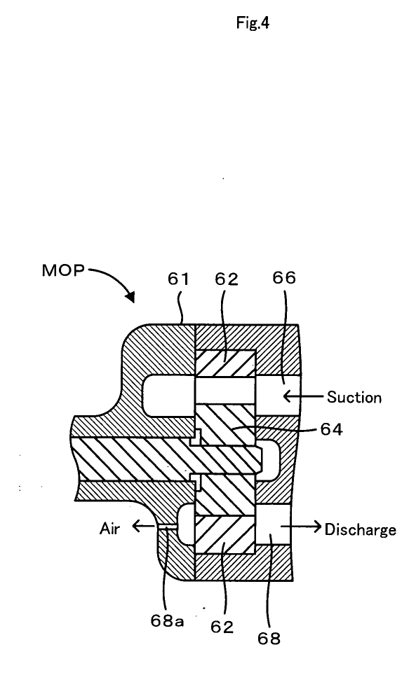

The mechanical oil pump MOP is configured to be connected to the crankshaft 13 of the engine 22 and operated by torque thereof. FIG. 4 shows an example of a sectional configuration of the mechanical oil pump MOP. As shown, the mechanical oil pump MOP is configured as a trochoid pump housed in a case 61, and constituted by an outer rotor 62 formed with internal teeth in an inner periphery, and an inner rotor 64 formed with outer teeth in an outer periphery and having a center of rotation that is eccentric with respect to a center of rotation of the outer rotor 62, and can suck oil through a suction port 66 along with rotation of the crankshaft 13 (see FIG. 3) of the engine 22 mounted to the inner rotor 64 and feed the oil through a discharge port 68. The case 61 is formed with a through hole 68a for releasing air that communicates with the discharge port 68. The through hole 68a has a diameter (for example, φ0.6) designed so as to facilitate discharge of air trapped in the mechanical oil pump MOP and inhibit discharge of oil. Thus, air trapped in when the mechanical oil pump MOP starts driving along with a start of the engine 22 is discharged out of the case 61 through the through hole 68a. Space outside the case 61 communicates with the oil tank 42 (see FIG. 3), and slight oil discharged together with the air through the through hole 68a is again stored into the oil tank 42.

An operation of the driving device 40 thus configured of the embodiment will be described. The case where the operation mode is switched from the motor operation mode to the engine motor operation mode will be now considered. In this case, the mechanical oil pump MOP starts operation along with the start of the engine. At this time, even when air is trapped in the mechanical oil pump MOP, the air is quickly discharged out of the case 61 through the through hole 68a along with the operation of the mechanical oil pump MOP. This quickly increases pressure on the discharge side of the mechanical oil pump MOP to pressure required for opening the check valve 46, and thus oil discharged from the mechanical oil pump MOP is quickly supplied to a necessary brake of the transmission 30 via the check valve 46. Thus, no delay in operation of the transmission 30 occurs when the mechanical oil pump MOP is operated.

According to the driving device 40 of the embodiment described above, the through hole 68a that communicates with the discharge port 68 is formed in the case 61 of the mechanical oil pump MOP, and thus air trapped in when the operation of the mechanical oil pump MOP is started can be quickly discharged out of the case 61 through the through hole 68a. Thus, pressure on the discharged side of the mechanical oil pump MOP can be quickly increased to pressure required for opening the check valve 48 without using a pump with excessive performance, and the oil discharged from the mechanical oil pump MOP can be quickly supplied to a necessary brake of the transmission 30 to quickly operate the brake.

In the driving device 40 of the embodiment, the through hole 68a for releasing air that communicates with the discharge port 68 is formed in the case 61 of the mechanical oil pump MOP, but similarly, a through hole for releasing air that communicates with a discharge port may be formed in the case of the motor oil pump EOP.

The embodiment and its modified examples discussed above are to be considered in all aspects as illustrative and not restrictive. There may be many other modifications, changes, and alterations without departing from the scope or spirit of the main characteristics of the present invention.

### INDUSTRIAL APPLICABILITY

The technique of the present invention is preferably applicable to the manufacturing industries of a driving device for a transmission.

1. A driving device used for driving a clutch included in a transmission mounted on a vehicle, said driving device comprising:
a first pump that pumps a working fluid to be supplied to said clutch;
a first check valve provided on an output side of said first pump; and
an air discharge portion that is formed in a channel between said first pump and said first check valve and can discharge air trapped in said channel along with driving of said first pump.

2. A driving device according to claim 1, wherein said air discharge portion is a through hole having a diameter determined so as to facilitate discharge of air and inhibit discharge of the working fluid.

3. A driving device according to claim 1, wherein said first pump is a mechanical pump driven by power from an internal combustion engine mounted on said vehicle.

4. A driving device according to claim 1, further comprising:
a second pump that is provided in parallel with said first pump, and pumps the working fluid to be supplied to said clutch; and
a second check valve provided on an output side of said second pump.

5. A driving device according to claim 4, wherein said first pump is a mechanical pump driven by power from an internal combustion engine mounted on said vehicle, and said second pump is a motor pump driven by receiving supply of electric power.

6. A driving device according to claim 1, wherein said transmission is connected to a rotating shaft of a motor mounted on said vehicle and a drive shaft coupled to an axle, and an engagement state of said clutch is changed to switch a gear change stage to transmit power of the shafts.

7. A driving device according to claim 6, further comprising:
a second pump that is provided in parallel with said first pump, and pumps the working fluid to be supplied to said clutch; and
a second check valve provided on an output side of said second pump.

8. A driving device according to claim 7, wherein said first pump is a mechanical pump driven by power from an internal combustion engine mounted on said vehicle, and said second pump is a motor pump driven by receiving supply of electric power.
